(19) United States
(12) Patent Application Publication
(10) Pub. No.: US 2016/0085857 A1
(43) Pub. Date: Mar. 24, 2016

(54) GROUPING DATA USING DYNAMIC THRESHOLDS

(71) Applicant: International Business Machines Corporation, Armonk, NY (US)

(72) Inventors: Adam T. Clark, Mantorville, MN (US); Thomas J. Eggebraaten, Rochester, MN (US); Marie L. Setnes, Bloomington, MN (US)

(21) Appl. No.: 14/495,717

(22) Filed: Sep. 24, 2014

(51) Int. Cl. G06F 17/30

(52) U.S. Cl. CPC G06F 17/30705; G06F 17/30696

(57) ABSTRACT

A plurality of confidence values is classified into one of a plurality of classes in accordance with a first criterion that was defined prior to the plurality of confidence values being received. The plurality of confidence values represents confidence of answers to a query submitted to an answering system. A second set of one or more thresholds based, at least in part, on the plurality of confidence values is determined. Unclassified ones of the plurality of confidence values are classified into one of the plurality of classes based, at least in part, on a number of the plurality of classes and the second set of one or more thresholds. The answers represented by the plurality of confidence values are presented in accordance with the classification of the plurality of confidence values into the plurality of classes.

### BACKGROUND

Embodiments of the inventive subject matter generally relate to the field of computer systems, and, more particularly, to grouping data of a question answering system using dynamic thresholds.

When a user submits a query to a question answering system (QA system), the system may return a single answer it determines to be the most correct. Also, a QA system may return a number of answers that are associated with answer confidence values. Some QA systems use static thresholds to sort answers into buckets and present answers to users in their associated buckets.

### SUMMARY

Embodiments generally include a method that includes classifying a plurality of confidence values into one of a plurality of classes in accordance with a first criterion that was defined prior to the plurality of confidence values being received. The plurality of confidence values represents confidence of answers to a query submitted to an answering system. The method further includes determining a second set of one or more thresholds based, at least in part, on the plurality of confidence values. The method further includes classifying unclassified ones of the plurality of confidence values into one of the plurality of classes based, at least in part, on a number of the plurality of classes and the second set of one or more thresholds. The method further includes presenting the answers represented by the plurality of confidence values in accordance with the classification of the plurality of confidence values into the plurality of classes.

### BRIEF DESCRIPTION OF THE DRAWINGS

The present embodiments may be better understood, and numerous objects, features, and advantages made apparent to those skilled in the art by referencing the accompanying drawings.

FIG. 1 is a conceptual diagram depicting a QA system that associates answers with buckets using multiple sets of thresholds.

FIG. 2 depicts a flow diagram illustrating example operations for associating answers with buckets.

FIG. 3 depicts a flow diagram illustrating example operations for associating answers with buckets using answer quality thresholds and calculated thresholds.

FIG. 4 depicts a flow diagram illustrating example operations for determining bucket thresholds for a set of answer confidence values based on the size of gaps between answer confidence values.

FIG. 5 depicts a flow diagram illustrating example operations for determining bucket thresholds for a set of answer confidence values based on the rates of change for each answer confidence value.

FIG. 6 depicts an example computer system with a dynamic data grouping unit.

### DESCRIPTION OF EMBODIMENT(S)

The description that follows includes example systems, methods, techniques, instruction sequences and computer program products that embody techniques of the present inventive subject matter. However, it is understood that the described embodiments may be practiced without these specific details. For instance, although examples refer to an answer confidence value being indicated by a normalized number between zero and one, an answer confidence value may be indicated using any kind of indicator that represents the level of confidence in an answer. In other instances, well-known instruction instances, protocols, structures and techniques have not been shown in detail in order not to obfuscate the description.

A QA system allows a user to submit a query for answering. The QA system generally returns a number of possible answers that are associated with answer confidence values. Returning the answers and answer confidence values alone may overwhelm a user or lead to misinterpretations of the quality of a returned answer. Grouping answers into buckets makes the returned answers easier to display and interpret. Buckets contain a group of answers and are typically associated with one or more threshold values and a descriptive label. When using buckets, the QA system determines which answers to associate with which buckets by comparing the answer confidence values to bucket thresholds. Using static bucket thresholds allows answers to be presented according to broadly accepted standards. For instance, an answer confidence above 95 on a scale of 0-100 would attribute high confidence to the corresponding answer. But using static bucket thresholds alone disregards the relative value of a set of answers. For instance, all answer confidence values may fall into a single bucket when static bucket thresholds are used. A single bucket of answers does not indicate relative confidence with respect to other answers in the bucket. With dynamic bucket thresholds, a QA system can determine bucket thresholds based on the answer confidence values. Since the dynamic bucket thresholds are based on answer confidence values, the QA system can create bucket thresholds that capture the relative confidence of the answers. In addition, using both static and dynamic bucket thresholds allows a QA system to present answers in a manner that captures relative confidence within a framework of a broadly accepted standard of confidence.

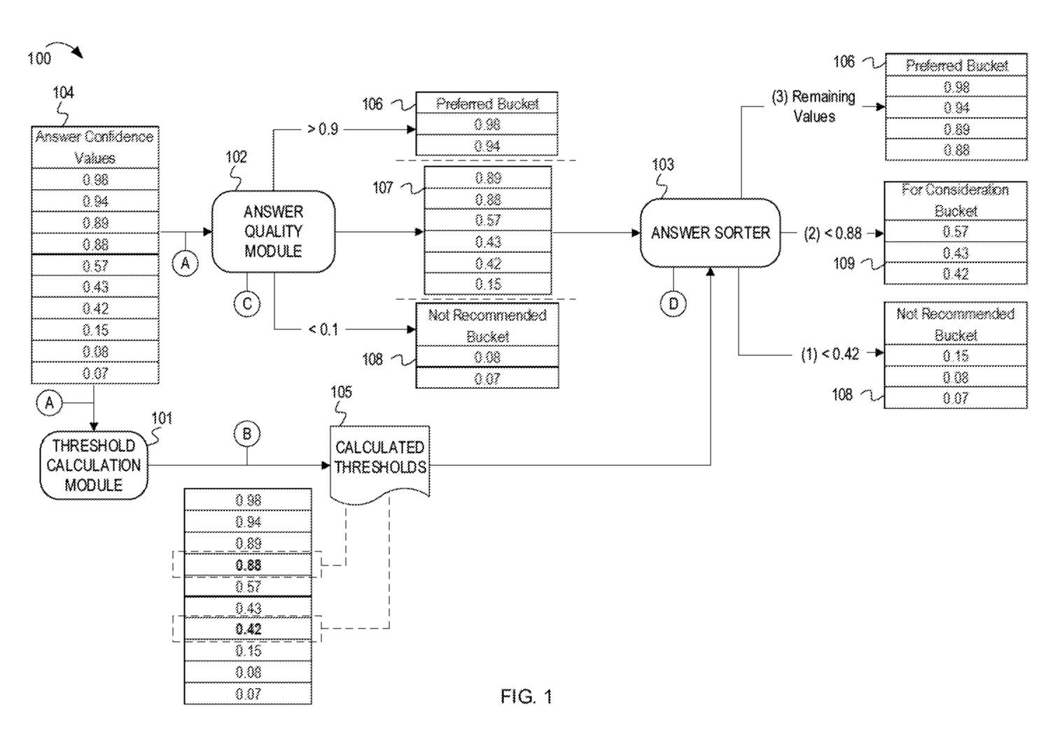

FIG. 1 is a conceptual diagram illustrating a QA system that classifies answers with buckets using multiple sets of thresholds. FIG. 1 depicts a QA system 100 including a threshold calculation module 101, an answer quality module 102, and an answer sorter 103. Answer confidence values 104 serve as an input to the threshold calculation module 101 and the answer quality module 102. The threshold calculation module 101 calculates thresholds 105 based on the answer confidence values 104. The answer quality module 102 classifies some of the answer confidence values 104 with buckets, and the answer confidence values not classified with a bucket by the answer quality module 102 are unclassified answer confidence values 107. FIG. 1 depicts three buckets, a “preferred” bucket 106, a “for consideration” bucket 109, and a “not recommended” bucket 108. The unclassified answer confidence values 107 and the calculated thresholds 105 serve as inputs into the answer sorter 103. FIG. 1 depicts a series of stages A-D. These stages illustrate example operations and should not be used to limit scope of any claims.

At stage A, the answer quality module 102 and the threshold calculation module 101 receive the answer confidence values 104. The threshold calculation module 101 and the answer quality module 102 may receive the answer confidence values 104 in parallel or sequentially. The answer quality module 102 and the threshold calculation module 101 generally receive the answer confidence values 104 from another component of the QA system 100, such as an answer module that generates the answer confidence values 104 and the corresponding answers.

At stage B, the threshold calculation module 101 calculates thresholds 105. To calculate the calculated thresholds 105, the threshold calculation module 101 analyzes the answer confidence values 104. The calculated thresholds 105 may be calculated in a number of ways. For example, the threshold calculation module 101 can use a data clustering technique, such as Jenk's natural breaks optimization. As another example, the threshold calculation module 101 can identify gaps and/or rates of changes associated with the answer confidence values (described in more detail below). The number of calculated thresholds 105 will be one less than the number of buckets used (i.e., one per boundary between buckets). For example, in FIG. 1, a first threshold (0.88) is calculated that distinguishes the “preferred” bucket 106 from the “for consideration” bucket 109. A second threshold (0.42) is calculated that distinguishes between the “for consideration” bucket 109 and the “not recommended” bucket 108. Thus, because three buckets are used, two thresholds will be calculated. These threshold values are used by the answer sorter 103 at stage D.

At stage C, the answer quality module 102 classifies answer confidence values 104 with the “preferred” bucket 106 and the “not recommended” bucket 108 based on static thresholds. Answer confidence values not classified with the “preferred” bucket 106 and the “not recommended” bucket 108 are the unclassified answer confidence values 107. For example, the answer quality module 102 applies the answer quality thresholds of “0.9” and “0.1” for the “preferred” bucket 106 and the “not recommended” bucket 108, respectively. Therefore any of the answer confidence values 104 above a 0.9 will be placed into the “preferred” bucket 106, and, likewise, any of the answer confidence values 104 below 0.1 will be placed into the “not recommended” bucket 108. The static thresholds are determined before the answer confidence values 104 are received and allow a user to set answer quality thresholds that will place certain answer confidence values into a particular bucket no matter the value of the calculated thresholds 105. In other words, the static thresholds can override the calculated thresholds 105. Similar to the calculated thresholds 105, the static thresholds may identify the boundaries between buckets. Further, the static thresholds might be determined by another component of the QA system 100. For example, a QA system component might monitor how often users select answers that fall outside of the “preferred” bucket 106 and adjust the static thresholds accordingly. The ungrouped answer confidence values 107 are used by the answer sorter 103 at stage D.

At stage D, the answer sorter 103 applies the calculated thresholds 105 to the ungrouped answer confidence values 107. The answer sorter 103 uses the calculated thresholds 105 to determine in which bucket an answer confidence value from the unassociated answer confidence values 107 belongs. The answer sorter 103 compares each of the unassociated answer confidence values 107 to the lowest of the calculated thresholds 105. Thus, the answer sorter 103 associates the unassociated answer confidence values 107 that are less than the lowest of the calculated thresholds 105 (0.42 in this example) with the “not recommended” bucket 108. Next, the answer sorter 103 associates the still unassociated answer confidence values that are less than the next highest calculated threshold 105 (0.88 in this example) with the “for consideration” bucket 109. Finally, any answer confidence values left over are associated with the “preferred” bucket 106. The answer confidence values that the answer sorter 103 associates with the buckets are in addition to the answer confidence values previously associated with the buckets by the answer quality module 102. The answer sorter 103 can group answer confidence values into buckets without regard to the order of the answer confidence values or the order of the buckets. The answer sorter 103 may use techniques where answer confidence values are associated into buckets in an order from least to greatest, from greatest to least, or in a random order.

As described above at stage C, the answer quality thresholds can override the calculated thresholds 105. For example, assume that the lower static thresholds used by the answer quality module 102 was “less than 0.5”. In this case, the answer quality module 102 would associate the answer confidence values 104 of 0.43, 0.42, and 0.15 with the “not recommended” bucket 108, despite the fact the answer sorter 103 would associate values 0.43 and 0.42 with the “for consideration” bucket 109 based on the calculated thresholds 105. The QA system 100 may also have the calculated thresholds override the answer quality thresholds. For example, if all returned answers have an answer confidence value in the range 0.9 to 1.0, the QA system 100 may select to have the calculated thresholds override the answer quality thresholds in order to prevent all returned answers from being associated with the “preferred” bucket 106.

The example depicted in FIG. 1 assumes that the number of buckets is appropriate to the number of answers. Scenarios can arise in which the number of answers is near the number of buckets, thereby reducing the usefulness of calculating the thresholds based on the answer confidence values. In those scenarios, the QA system 100 might revert to using static thresholds. In contrast to calculated thresholds, static thresholds may be the same for each set of answer confidence values. The static thresholds are determined before a set of answer confidence values is received. Static thresholds may be defined in configuration data or determined by a module of the QA system 100 based on certain parameters, such as the number of buckets.

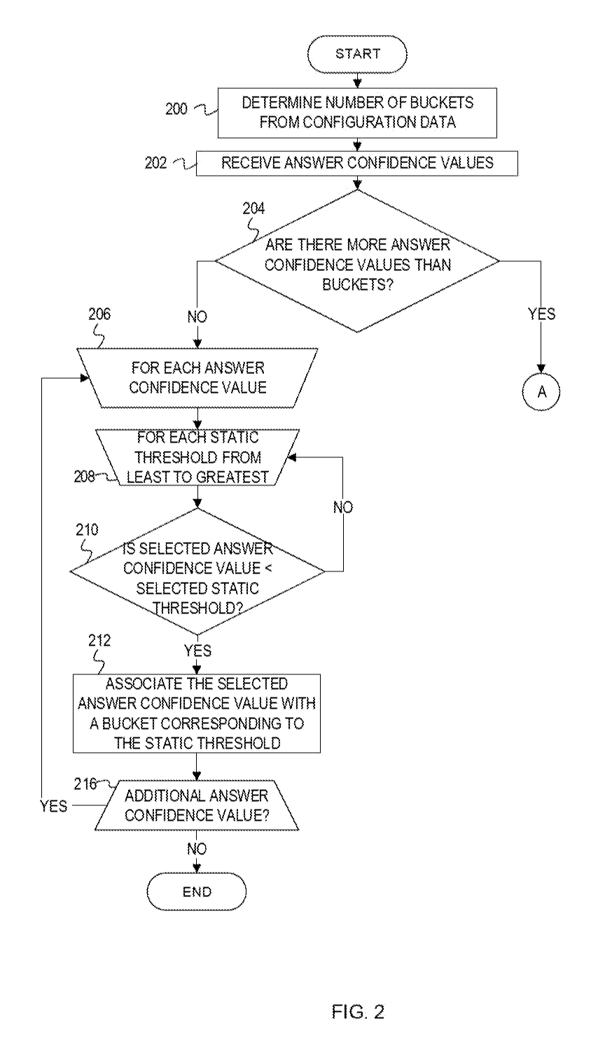

FIG. 2 depicts a flow diagram illustrating example operations for associating answer confidence values with buckets.

At block 200, a number of buckets is determined from configuration data. There are typically at least two buckets, but the specific number of buckets can vary. For example, it may be determined based on user experiments that a particular number of buckets is optimal for a given scenario or set of scenarios (e.g., for questions from a particular source). In general, however, too many buckets can negate the advantages of buckets. For example, if there was a bucket for each answer, the buckets might not generate an informative presentation of the answers. Further, system resources, such as processor speed and memory available might impose a practical limit on the number of buckets. The number of buckets might also be variable. For example, the number of buckets might change in proportion to the number of answers determined for a particular query. Once the number of buckets has been determined, control then flows to block 202.

At block 202, a set of answer confidence values is received. Each answer confidence value is associated with an answer. The answer confidence values can be specified in various manners. For example, the answer confidence values can be specified as percentages (or fractions of 100), integers within a particular range, etc. After the answer confidence values are received, control then flows to block 204.

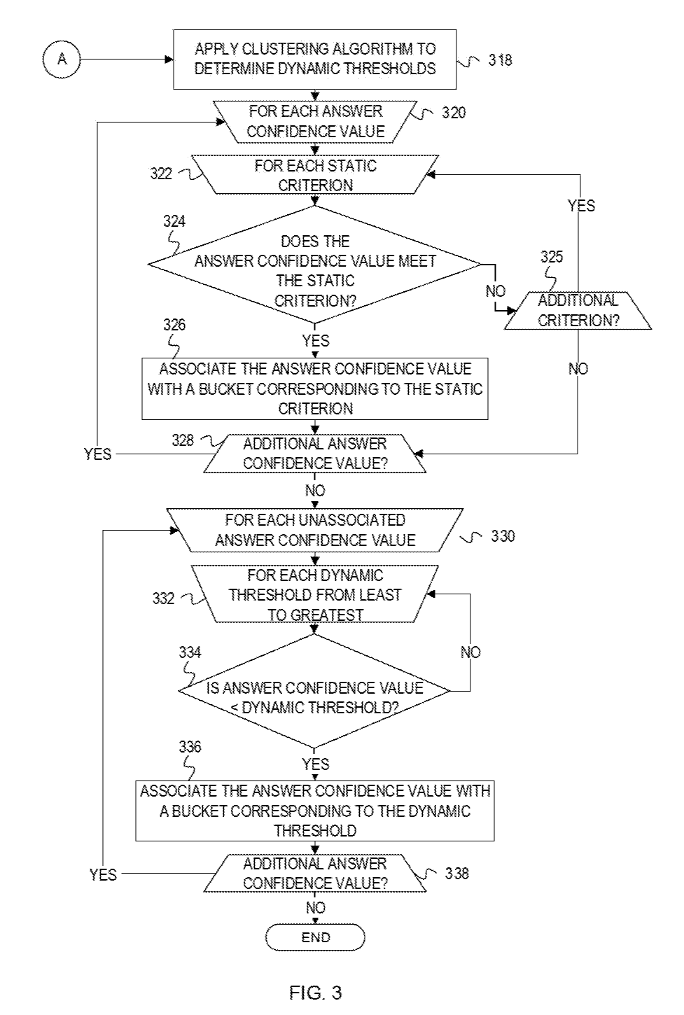

At block 204, it is determined whether there are more answer confidence values than buckets. The number of buckets is the number determined at block 200. The number of answer confidence values is equal to the number of answer confidence values received in block 202. If there are more answer confidence values than buckets, control then flows to block 318 in FIG. 3. If there are not more answer confidence values than buckets, control then flows to block 206.

At block 206, a loop in which each answer confidence value is iterated over begins. The answer confidence value currently being iterated over is referred to hereinafter as the “selected answer confidence value”. During the first pass through block 206, the selected answer confidence value is initialized to a first answer confidence value. On each subsequent pass through block 206, the selected answer confidence value is updated to be the next answer confidence value. The loop continues until all answer confidence values have been iterated over. After the selected answer confidence value has been initialized or updated, control then flows to block 208.

At block 208, a nested loop in which a set of static thresholds is iterated over begins. The static thresholds are iterated over from least to greatest. The current static threshold currently being iterated over is referred to hereinafter as the “selected static threshold”. The static thresholds are used to distinguish one bucket from another bucket. Static thresholds may have been entered by a user, may be calculated based on the number of buckets, etc. Additionally, a different number of buckets than the number determined at block 200 may be used. During an initial pass through block 208 after block 206, the selected static threshold is initialized to the lowest static threshold. On each subsequent pass through block 208, the selected static threshold is updated to be the next greatest static threshold. The nested loop continues until the selected answer confidence value is less than the selected static threshold. The nested loop will reinitialize on each iteration of the loop beginning at block 206. After the selected static threshold has been initialized or updated, control then flows to block 210.

At block 210, it is determined whether the selected answer confidence value is less than the selected static threshold. In other words, the selected answer confidence value is compared to the selected static threshold. If the answer confidence value is not less than the selected static threshold, control then returns to block 208. If the answer confidence value is less than the selected static threshold, the nested loop is terminated and control then flows to block 212.

At block 212, the selected answer confidence value is associated with a bucket corresponding to the selected static threshold. For example, if the nested loop at block 208 went through two iterations, then the selected answer confidence value becomes associated with a bucket corresponding to the second greatest static threshold. An answer confidence value may be associated with a bucket by inserting the answer confidence value or a pointer to the answer confidence value into a data structure representing a bucket, inserting in a data structure representing the answer confidence value an identifier for the associated bucket, etc. Once the selected answer confidence value has been associated with the bucket, control then flows to block 216.

At block 216, it is determined whether there is an additional answer confidence value. If there is an additional answer confidence value that has not been associated with a bucket, control then returns to block 206. If all answer confidence values have been associated with a bucket, then the loop beginning at 206 terminates and the process ends.

As described above at block 204, the number of answer confidence values is compared to the number of buckets. If there are not more answers than buckets, static thresholds are used to associate answer confidence values with buckets. If there are more answers than buckets, calculated thresholds are used, as described below. Calculated thresholds might not be effective when there are more buckets than answer confidence values because of the fact that there are not enough answer confidence values to serve as thresholds for the buckets. Therefore, in such cases, using static thresholds may be more effective. There may be other cases where using static thresholds is more effective. For example, in cases where the number of answer confidence values is only one more than the number of buckets. In such cases, a percentage or ratio comparing the number of answer confidence values to the number of buckets may be used to determine whether using calculated thresholds or static thresholds would be more effective.

FIG. 3 depicts a flow diagram illustrating example operations for associating answers with buckets using answer quality criteria and calculated thresholds.

Control flowed to block 318 if it was determined, at block 204 of FIG. 2, that there are more answers than buckets. At block 318, a clustering algorithm is used to determine dynamic thresholds. In contrast to the static thresholds applied in the nested loop 208, the dynamic thresholds are determined based on the received answer confidence values and may be different for different sets of answer confidence values. The dynamic thresholds may be determined in a number of ways. For example, the dynamic thresholds may be determined by using a data clustering technique, such as Jenk's natural breaks optimization. As another example, the dynamic thresholds may be determined by using techniques that include identifying gaps and/or rates of changes associated with the answer confidence values. The dynamic thresholds are associated with buckets based on the number of buckets and dynamic thresholds. In some embodiments, the dynamic thresholds can be used to define additional buckets.

At block 320, a loop in which each answer confidence value is iterated over begins.

At block 322, a nested loop in which each static criterion is iterated over begins. Answer quality criteria allow answer confidence values to be associated with a specific bucket regardless of the other answer confidence values. Answer quality criteria may be generated by a module of the QA system or may be determined from configuration data. For example, configuration data may indicate that answer confidence values below 0.3 should be placed in a “not preferred” bucket. Therefore, answer confidence values less than 0.3 will be placed in the “not preferred” bucket even if the answer confidence value would be associated with a different bucket based on the thresholds determined in block 318.

At block 324, it is determined whether the answer confidence value meets the static criterion. If the answer confidence value does not meet the static criterion, control then flows to block 325. If the answer confidence value does meet the static criterion, control then flows to block 326.

At block 325, it is determined whether there is an additional static criterion. If there is an additional static criterion, control returns to block 322. If each static criterion has been compared to the selected answer confidence value, then the nested loop beginning at block 322 terminates and control then flows to block 328.

Control flowed to block 326 if it was determined, at block 324, that the answer confidence value does meet the static criterion. At block 326, the answer confidence value is associated with a bucket corresponding to the static criterion. An answer confidence value may be associated with a bucket by inserting the answer confidence value or a pointer to the answer confidence value into a data structure representing a bucket. As another example, associating an answer confidence value with a bucket can be inserting an identifier for the associated bucket in a data structure that indicates the answer confidence value. Once the answer confidence value has been associated with the bucket, control then flows to block 328.

Control flowed to block 328 if it was determined, at block 325, that there were no additional answer quality criteria. Control also flowed to block 328 from block 326. At block 328, it is determined whether there is an additional answer confidence value. If there is an additional answer confidence value, then control returns to block 320. If the answer confidence values have been evaluated against the answer quality criteria, then the loop beginning at 320 terminates and control then flows to block 330.

At block 330, a loop in which each unassociated answer confidence value is iterated over begins. The unassociated answer confidence values are those that were not associated with a bucket at block 326.

At block 332, a nested loop in which each calculated threshold is iterated over begins. The calculated thresholds are iterated over from least to greatest.

At block 334, it is determined whether the unassociated answer confidence value is less than the dynamic threshold. If the unassociated answer confidence value is not less than the dynamic threshold, control returns to block 332. If the unassociated answer confidence value is less than the dynamic threshold, the nested loop is terminated and control then flows to block 336.

At block 336, the unassociated answer confidence value is associated with a bucket corresponding to the dynamic threshold. For example, if the nested loop at block 332 went through two iterations, then the ungrouped answer confidence value is associated with a bucket corresponding to the second greatest dynamic threshold. An unassociated answer confidence value may be associated with a bucket by inserting the answer confidence value or a pointer to the answer confidence value into a data structure representing a bucket, inserting in a data structure representing the answer confidence value an identifier for the associated bucket, etc. Once the unassociated answer confidence value has been associated with the bucket, control then flows to block 338.

At block 338, it is determined whether there is an additional unassociated answer confidence value. If there is an additional unassociated answer confidence value that has not been compared to the dynamic thresholds, control returns to block 330. If all unassociated answer confidence values have been associated with a bucket, then the loop beginning at 330 terminates and the process ends.

As described above, the answer quality criteria may consist of numerical parameters such as ranges or greater than or less than values. Additionally, the answer quality criteria may be non-numerical parameters. For example, an answer, in addition to being associated with an answer confidence value, may be associated with other data parameters, such as whether the answer is a known good answer, number of times the answer has been viewed, or amount of evidence supporting the answer. An example of another static criterion is “answers that have been viewed more than 100 times.” Meeting such a criterion might result, for example, in an answer confidence value being placed in a “preferred” bucket. Additionally, for example, if an answer is a known good answer, it may automatically be placed in a “preferred” bucket, or, vice versa, a known bad answer in a “not preferred” bucket. Also, a static criterion might be that if an answer is only supported by a small amount of evidence, then it might be associated with a “for consideration” bucket. Evidence that supports an answer may be text from a document located in the corpus of the QA system.

As described above, dynamic thresholds can be determined by identifying gaps among the answer confidence values. For example, the size of gaps between answer confidence intervals can be analyzed for gaps over a certain threshold. The size of the gaps can be compared to the standard deviation of all of the gaps, for example. Additionally, the mean variance between answer confidence values may be calculated, and the gaps can be compared to the mean variance. The answer confidence values with gaps greater than or equal to the mean variance or the standard deviation may be used as bucket thresholds.

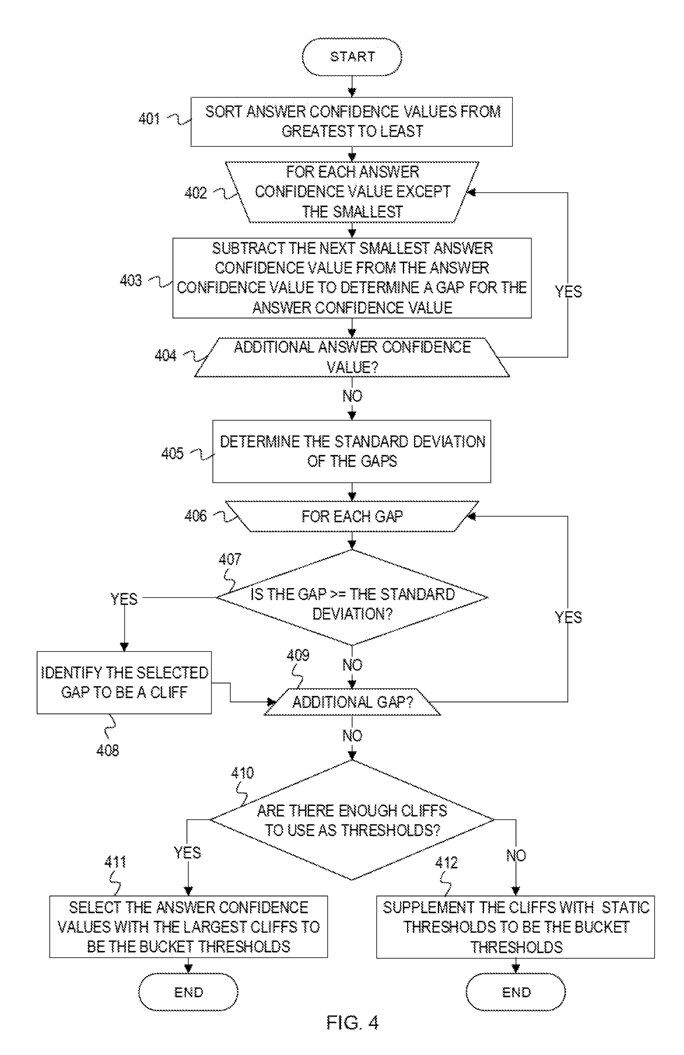

FIG. 4 depicts a flow diagram illustrating example operations for determining bucket thresholds for a set of answer confidence values based on the size of gaps between answer confidence values.

At block 401, answer confidence values are sorted from greatest to least. The answer confidence values may be sorted using any suitable sorting technique, such as quicksort, mergesort, etc. Once the answer confidence values have been sorted, control then flows to block 402.

At block 402, a loop in which each answer confidence value except the smallest is iterated over begins.

At block 403, the next smallest answer confidence value is subtracted from the answer confidence value to determine a gap. The gap for the selected answer confidence value is the difference between the answer confidence value and the next smallest answer confidence value. Once the gap for each answer confidence value except the smallest has been determined, control then flows to block 404.

At block 404, it is determined whether there is an additional answer confidence value. If the gap for each of the answer confidence values except the smallest has not been determined, control returns to block 402. If the gap for each of the answer confidence values except the smallest has been determined, control then flows to block 405.

At block 405, the standard deviation of the gaps is determined. Once the standard deviation of the gaps has been calculated, control then flows to block 406.

At block 406, a loop in which each gap is iterated over begins.

At block 407, it is determined whether the selected gap is greater than or equal to the standard deviation. If the selected gap is not greater than or equal to the selected gap, control flows to block 409. If the selected gap is greater than or equal to the selected gap, control then flows to block 408.

At block 408, the gap is identified to be a cliff. The cliff is a gap for an answer confidence value that is greater than or equal to the standard deviation of all the gaps. There may be multiple cliffs for a set of answer confidence values. After the gap is identified to be a cliff, control then flows to block 409.

Control flowed to block 409 if it was determined, at block 407, that the selected gap was not greater than or equal to the standard deviation. Control also flowed to block 409 from block 408. At block 409, it is determined whether there is an additional gap. If each gap has not been compared to the standard deviation, control returns to block 406. If each gap has been compared to the standard deviation, control then flows to block 410.

At block 410, it is determined whether there are enough cliffs to use as thresholds. For instance, a minimum number of cliffs can be equal to one less than the number of buckets. If there are enough cliffs, control flows to block 411. If there are not enough cliffs, control then flows to block 412.

At block 411, the answer confidence values with the largest cliffs are selected to be the bucket thresholds. The number of answer confidence values selected is equal to one less than the number of buckets. So, for example, if there are five cliffs but only three buckets, then the two answer confidence values with the largest cliffs will be selected to be bucket thresholds. After the answer confidence values with the largest cliffs are selected to be the bucket thresholds, the process ends.

Control flowed to block 412 if it was determined, at block 410, that there are not enough cliffs to use as thresholds. At block 412, static thresholds are used to supplement the cliffs as bucket thresholds. Because there are not a sufficient number of cliffs to use as thresholds, the static thresholds will be used in addition to the cliffs. In some embodiments, the static thresholds are used instead of the cliffs assuming there are enough static thresholds.

Rates of change among the answer confidence values can also be used for determining dynamic thresholds. The rate of change for each answer confidence value can be determined. The rate of change for an answer confidence value may be determined by taking the second derivative of a line formed between the answer confidence value and a subsequent answer confidence value. The answer confidence values with the greatest rates of change can then be used as bucket thresholds.

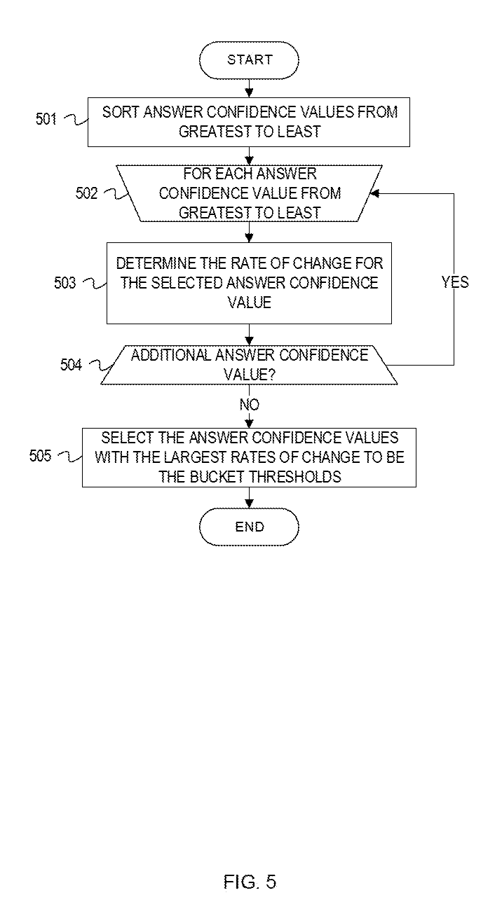

FIG. 5 depicts a flow diagram illustrating example operations for determining bucket thresholds for a set of answer confidence values based on the rates of change for each answer confidence value.

At block 501, answer confidence values are sorted from greatest to least. The answer confidence values may be sorted using any suitable sorting technique, such as quicksort, mergesort, etc. Once the answer confidence values have been sorted, control then flows to block 502.

At block 502, a loop in which each answer confidence value is iterated over begins. The answer confidence values are iterated over from greatest to least.

At block 503, a rate of change for the selected answer confidence value is determined. The rate of change for the selected answer confidence value is the rate of change between the selected answer confidence value and the next smallest answer confidence value. The rate of change for a selected answer confidence value may be determined by taking the second derivative of a line defined by the answer confidence value and the next smallest answer confidence value. For example, the derivative between two points on an x and y plane may be calculated by using the formula y2−y1/x2−x1. In this instance, y1 is the answer confidence value and y2 is the next smallest answer confidence value. The x values are determined by the placement of the answer confidence value in the sorted list. If the answer confidence value is first in the list, its x value is one, and the x value of the next smallest answer confidence value is 2, and so on. A first derivative of the selected answer confidence value can be taken using the formula above, which generates a first derivative value of y1′. To take a second derivative, the same formula may be used by substituting the y1 and y2 values for the first derivative values of y1′ and y2′. The second derivative value is the rate of change for the selected answer confidence value. Other suitable techniques to determine the rate of change may be used. The rate of change is not necessarily determined between adjacent answer confidence values. Embodiments may filter out some of the answer confidence values. The rate of change can then be computed between the remaining answer confidence values based on their positions prior to the filtering. After the rate of change for the selected answer confidence value has been determined, control then flows to block 504.

At block 504, whether there is an additional answer confidence value is determined. If the rate of change for each answer confidence value has not been determined, control returns to block 502. If the rate of change for each answer confidence value has been determined, control then flows to block 505.

At block 505, the answer confidence values with the largest rates of change are selected to be bucket thresholds. For example, if there are three buckets, then the answer confidence values with the two largest rates of change will be selected to be bucket thresholds. After answer confidence values with the largest rates of change are selected to be bucket thresholds, the process ends.

It should be noted that the operations described in the flow diagrams (FIGS. 2-5) are examples meant to aid in understanding embodiments, and should not be used to limit embodiments or limit scope of the claims. Embodiments may perform additional operations, fewer operations, operations in a different order, operations in parallel, and some operations differently. For example, a set of answer confidence values may be received (block 202 of FIG. 2) before a number of buckets is determined from the configuration data (block 200 of FIG. 2). As another example, the generation of calculated thresholds that occurs (block 318 of FIG. 3) may be performed at any time before the calculated thresholds are used and may be done in parallel to other operations.

Additionally, some operations above iterate through sets of items, such as the answer confidence values, in an order from least to greatest. In some implementations, the operations may sort the items from greatest to least, sort the items based on other thresholds, or may not sort at all. The iterations can thus be performed according to the particular techniques used to sort the sets. Also, the number of iterations for loop operations may vary. For example, a loop may not iterate for each answer confidence value (block 206 of FIG. 2). A loop may exit early after a certain number of answer confidence values have been associated with buckets, or a QA system may determine that answer confidence values below a certain threshold should not be considered by loop operations. Additionally, different techniques for associating answers with buckets may require fewer iterations or more iterations.

The use of the word “static” to describe thresholds and criteria does not mean that the thresholds or criteria never change or can only change based on user manipulation. As mentioned above, static thresholds and static criteria may change based on certain parameters, such as the number of buckets or the number of times an answer is selected by a user. Based on such parameters, a static threshold or static criterion may not change, may change little, or may change infrequently. For example, if the number of buckets changes, then the static thresholds may change to accommodate the different number of buckets but will remain the same until a new number of buckets is determined. While the static thresholds and static criteria are determined before a set of answer confidence values are received, they may change before or after answer confidence values are received.

The description uses the term “bucket” to refer to a construct that represents a grouping of data items. A “bucket” is used to organize or classify the data items into different groups. The bucket may be implemented as a tag or an identifier. To illustrate, a system may have two buckets, “bucket_1” and “bucket_2.” Two different arrays can be named “bucket_1” and “bucket_2”. The bucket_1 array can be populated with the values that equal or exceed a threshold. The bucket_2 array can be populated with the values that are less than the threshold. Alternatively, each value can be tagged or associated with a variable that indicates either bucket_1 or bucket_2. As another example, values greater than or equal to the threshold can be stored in a region of memory designated for bucket_1. Furthermore, the groupings of data items can be considered classification of the data items. Grouping data items into buckets can be considered classifying data items when the groups indicate classes of data items. In the FIG. 1 example, some answer confidence values are classified as “preferred” answer confidence values while other answer confidence values are classified as “not preferred.” Even though the answers are typically considered classified, the answers are classified based on classification of the corresponding answer confidence values.

Each of the answer confidence values is associated with an answer. Once the answer confidence values are sorted into buckets, a QA system associates the answers with the buckets based on their associated answer confidence value. The answers are then presented via the QA system. The answers may be presented according to their bucket groupings or classifications. The QA system may display the answers in a particular order, such as sorted by classification, or may only display answers belonging to a specific classification. For example, in the FIG. 1 example, the answers associated with the answer confidence values 0.15, 0.08, and 0.07 may be presented according to a “not recommended” classification. The “not recommended” classification answers may be presented near the bottom of a user display, in red font, or along with some indication that the answers have low confidence values. In addition, the answers corresponding to answer confidence values classified or associated with the “not recommended” bucket may not be displayed if there are at least n other answers. Conversely, in the FIG. 1 example, the answers associated with the answer confidence values 0.98, 0.94, 0.89, and 0.88 may be presented according to a “preferred” classification. The “preferred” classification answers may be presented near the top of a user display, in green font, or along with some indication that the answers have high confidence values. Finally, the answer confidence values associated with the “for consideration” bucket in FIG. 1 may be presented according to a “for consideration” classification. The “for consideration” answers may be presented in the middle of a user display, in yellow font, or along with some indication that the answers have do not have high confidence values but still may be helpful.

A QA system in the description may be any type of answering system. An answering system is a type of information retrieval system. The answering system may be a system that hosts a database of predetermined answers and that provides relevant answers in response to specific queries. Additionally, an answering system may be able to employ natural language processing to identify answers within a corpus of information. An answering system may be embodied on a machine, such as a server, desktop computer, portable device, etc. To illustrate, a query may be submitted on a portable device. The answers and corresponding answer confidence values may then be provided from a backend (e.g., a remote machine with data analysis technology). That backend may classify the answer confidence values as described herein and return the answers to the portable device in accordance with the classification. In addition, the portable device itself can host program instructions that classify answers based on corresponding answered confidence values returned from the backed.

As will be appreciated by one skilled in the art, aspects of the present inventive subject matter may be embodied as a system, method and/or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in a computer readable storage medium (or media) having computer readable program instructions embodied thereon.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present inventive subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present inventive subject matter.

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

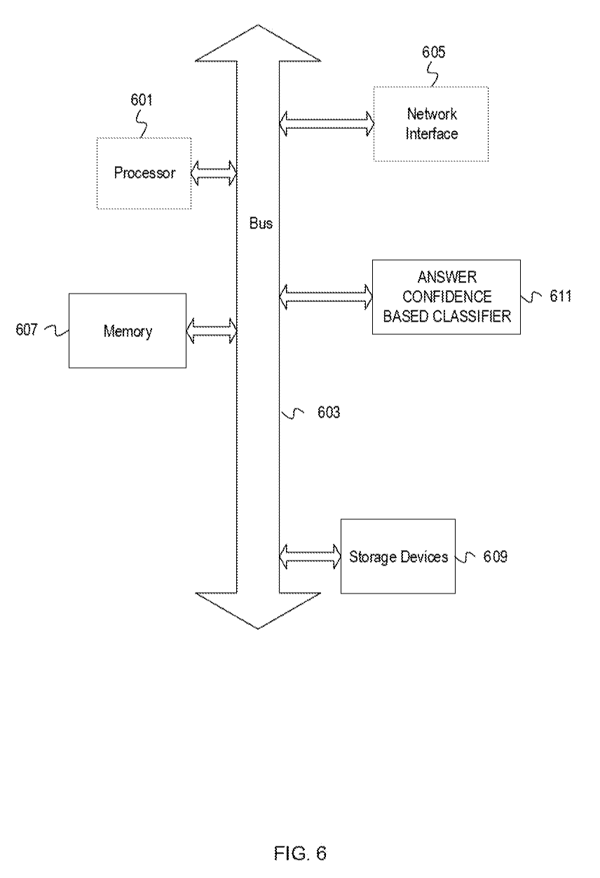

FIG. 6 depicts an example computer system with a dynamic data grouping unit. A computer system includes a processor 601 (possibly including multiple processors, multiple cores, multiple nodes, and/or implementing multi-threading, etc.). The computer system includes memory 607. The memory 607 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus YY03 (e.g., PCI, ISA, PCI-Express, HyperTransport®, InfiniBand®, NuBus, etc.), a network interface 605 (e.g., an ATM interface, an Ethernet interface, a Frame Relay interface, SONET interface, wireless interface, etc.), and a storage device(s) 609 (e.g., optical storage, magnetic storage, etc.). The answer confidence based classifier 611 embodies functionality to classify answers based on corresponding answer confidence values in accordance with static criteria and/or dynamic thresholds as described herein. The answer confidence based classifier 611 may perform operations that calculate thresholds for a given data set, apply answer quality thresholds to a data set, and associate data of the data set with classification constructs (e.g., buckets). Any one of these functionalities may be partially (or entirely) implemented in hardware and/or on the processing unit 601. For example, the functionality may be implemented with an application specific integrated circuit, in logic implemented in the processor 601, in a co-processor on a peripheral device or card, etc. Further, realizations may include fewer or additional components not illustrated in FIG. 6 (e.g., video cards, audio cards, additional network interfaces, peripheral devices, etc.). The processor 601, the storage device(s) 609, and the network interface 605 are coupled to the bus 603. Although illustrated as being coupled to the bus 603, the memory 607 may be coupled to the processor 601.

While the embodiments are described with reference to various implementations and exploitations, it will be understood that these embodiments are illustrative and that the scope of the inventive subject matter is not limited to them. In general, techniques for dynamically grouping data sets as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

Use of the phrase “at least one of . . . or” should not be construed to be exclusive. For instance, the phrase “X comprises at least one of A, B, or C” does not mean that X comprises only one of {A, B, C}; it does not mean that X comprises only one instance of each of {A, B, C}, even if any one of {A, B, C} is a category or sub-category; and it does not mean that an additional element cannot be added to the non-exclusive set (i.e., X can comprise {A, B, Z}).

What is claimed is:

1. A method comprising:
classifying at least a first set of a plurality of confidence values into one of a plurality of classes in accordance with a first criterion that was defined prior to the plurality of confidence values being received, wherein the plurality of confidence values represents confidence of answers to a query submitted to an answering system;
determining a second set of one or more thresholds based, at least in part, on the plurality of confidence values;
classifying unclassified ones of the plurality of confidence values into one of the plurality of classes based, at least in part, on a number of the plurality of classes and the second set of one or more thresholds; and
presenting, via the answering system, the answers represented by the plurality of confidence values in accordance with the classification of the plurality of confidence values into the plurality of classes.

2. The method of claim 1, wherein the first criterion comprises a static threshold, wherein said classifying at least a first set of a plurality of confidence values into one of a plurality of classes in accordance with a first criterion that was defined prior to the plurality of confidence values being received comprises one of:
determining that the first set of the plurality of confidence values is greater than the static threshold;
determining that the first set of the plurality of confidence values is equal to the static threshold; or
determining that the first set of the plurality of confidence values is less than the static threshold.

3. The method of claim 1, wherein said determining a second set of one or more thresholds based, at least in part, on the plurality of confidence values comprises:
determining a plurality of gaps, wherein each gap of the plurality of gaps comprises a gap between consecutive confidence values of the plurality of confidence values;
determining a standard deviation associated with the plurality of gaps;
determining one or more of the plurality of gaps that are one of greater than or equal to the standard deviation; and
using the one or more of the plurality of gaps as the second set of thresholds.

4. The method of claim 3 further comprising:
determining that a number of the second set of thresholds is insufficient for a number of the plurality of classes; and
using a third set of static thresholds to supplement the second set of thresholds.

5. The method of claim 1, wherein said determining a second set of one or more thresholds based, at least in part, on the plurality of confidence values comprises:
determining a plurality of rate changes, wherein each rate change of the plurality of rate changes comprises a rate change between consecutive confidence values of the plurality of confidence values;
determining one or more of the plurality of rate changes to be the largest of the plurality of rate changes; and
using the one or more of the plurality of rate changes as the second set of thresholds.

6. The method of claim 1, wherein said classifying at least a first set of a plurality of confidence values into one of a plurality of classes in accordance with a first criterion that was defined prior to the plurality of confidence values being received comprises associating an indication of the first class with an indication of at least one of the first set of the plurality of confidence values or the answer associated with the first set of the plurality of confidence values.

7. The method of claim 1, wherein the first criterion comprises at least one of:
a number of times an answer has been viewed;
a quality ranking for an answer; or
an amount of evidence supporting an answer.

8. A computer program product for classifying answers comprising:
a computer readable storage medium having program instructions embodied therewith, the program instructions comprising program instructions to,
classify at least a first set of a plurality of confidence values into one of a plurality of classes in accordance with a first criterion that was defined prior to the plurality of confidence values being received, wherein the plurality of confidence values represents confidence of answers to a query submitted to an answering system;
determine a second set of one or more thresholds based, at least in part, on the plurality of confidence values;
classify unclassified ones of the plurality of confidence values into one of the plurality of classes based, at least in part, on a number of the plurality of classes and the second set of one or more thresholds; and
present the answers represented by the plurality of confidence values in accordance with the classification of the plurality of confidence values into the plurality of classes.

9. The computer program product of claim 8, wherein the first criterion comprises a static threshold, wherein the program instructions to classify at least a first set of a plurality of confidence values into one of a plurality of classes in accordance with a first criterion that was defined prior to the plurality of confidence values being received comprises the program instructions to, one of:
determine that the first set of the plurality of confidence values is greater than the static threshold;
determine that the first set of the plurality of confidence values is equal to the static threshold; or
determine that the first set of the plurality of confidence values is less than the static threshold.

10. The computer program product of claim 8, wherein the program instructions to determine a second set of one or more thresholds based, at least in part, on the plurality of confidence values comprises the program instructions to:
determine a plurality of gaps, wherein each gap of the plurality of gaps comprises a gap between consecutive confidence values of the plurality of confidence values;
determine a standard deviation associated with the plurality of gaps;
determine one or more of the plurality of gaps that are one of greater than or equal to the standard deviation; and
use the one or more of the plurality of gaps as the second set of thresholds.

11. The computer program product of claim 10 further having program instructions to:
determine that a number of the second set of thresholds is insufficient for a number of the plurality of classes; and
use a third set of static thresholds to supplement the second set of thresholds.

12. The computer program product of claim 8, wherein the program instructions to determine a second set of one or more thresholds based, at least in part, on the plurality of confidence values comprises program instructions to:
determine a plurality of rate changes, wherein each rate change of the plurality of rate changes comprises a rate change between consecutive confidence values of the plurality of confidence values;
determine one or more of the plurality of rate changes to be the largest of the plurality of rate changes; and
use the one or more of the plurality of rate changes as the second set of thresholds.

13. The computer program product of claim 8, wherein the program instructions to classify at least a first set of a plurality of confidence values into one of a plurality of classes in accordance with a first criterion that was defined prior to the plurality of confidence values being received comprises the program instructions to associate an indication of the first class with an indication of at least one of the first set of the plurality of confidence values or the answer associated with the first set of the plurality of confidence values.

14. The computer program product of claim 8, wherein the first criterion comprises at least one of:
a number of times an answer has been viewed;
a quality ranking for an answer; or
an amount of evidence supporting an answer.

15. An apparatus comprising:
a processor; and
a computer readable storage medium having program instructions embodied therewith, the program instructions executable by the processor to cause the apparatus to,
classify at least a first set of a plurality of confidence values into one of a plurality of classes in accordance with a first criterion that was defined prior to the plurality of confidence values being received, wherein the plurality of confidence values represents confidence of answers to a query submitted to an answering system;
determine a second set of one or more thresholds based, at least in part, on the plurality of confidence values;
classify unclassified ones of the plurality of confidence values into one of the plurality of classes based, at least in part, on a number of the plurality of classes and the second set of one or more thresholds; and
present the answers represented by the plurality of confidence values in accordance with the classification of the plurality of confidence values into the plurality of classes.

16. The apparatus of claim 15, wherein the first criterion comprises a static threshold, wherein the program instructions executable by the processor to cause the apparatus to classify at least a first set of a plurality of confidence values into one of a plurality of classes in accordance with a first criterion that was defined prior to the plurality of confidence values being received comprises the program instructions executable by the processor to cause the apparatus to, one of:
determine that the first set of the plurality of confidence values is greater than the static threshold;
determine that the first set of the plurality of confidence values is equal to the static threshold; or
determine that the first set of the plurality of confidence values is less than the static threshold.

17. The apparatus of claim 15, wherein the program instructions executable by the processor to cause the apparatus to determine a second set of one or more thresholds based, at least in part, on the plurality of confidence values comprises the program instructions executable by the processor to cause the apparatus to:
determine a plurality of gaps, wherein each gap of the plurality of gaps comprises a gap between consecutive confidence values of the plurality of confidence values;
determine a standard deviation associated with the plurality of gaps;
determine one or more of the plurality of gaps that are one of greater than or equal to the standard deviation; and
use the one or more of the plurality of gaps as the second set of thresholds.

18. The apparatus of claim 17, wherein the computer readable storage medium further has program instructions executable by the processor to cause the apparatus to:
determine that a number of the second set of thresholds is insufficient for a number of the plurality of classes; and
use a third set of static thresholds to supplement the second set of thresholds.

19. The apparatus of claim 15, wherein the program instructions executable by the processor to cause the apparatus to determine a second set of one or more thresholds based, at least in part, on the plurality of confidence values comprises program instructions executable by the processor to cause the apparatus to:
determine a plurality of rate changes, wherein each rate change of the plurality of rate changes comprises a rate change between consecutive confidence values of the plurality of confidence values;
determine one or more of the plurality of rate changes to be the largest of the plurality of rate changes; and
use the one or more of the plurality of rate changes as the second set of thresholds.

20. The apparatus of claim 15, wherein the program instructions executable by the processor to cause the apparatus to classify at least a first set of a plurality of confidence values into one of a plurality of classes in accordance with a first criterion that was defined prior to the plurality of confidence values being received comprises the program instructions executable by the processor to cause the apparatus to associate an indication of the first class with an indication of at least one of the first set of the plurality of confidence values or the answer associated with the first set of the plurality of confidence values.
